(19) United States
(12) Patent Application Publication
(10) Pub. No.: US 2003/0230456 A1
(43) Pub. Date: Dec. 18, 2003

(54) Control method and device at truck

(76) Inventors: Per Gyllenhammar, Motala (SE); Mikael Jakauby, Linkoping (SE)

Correspondence Address: Norman P. Soloway, HAYES, SOLOWAY, HENNESSEY,, GROSSMAN & HAGE, P.C., 175 Canal Street, Manchester, NH, 03101, US

(21) Appl. No.: 10/453,025

(22) Filed: Jun. 3, 2003

(30) Foreign Application Priority Data
Jun. 5, 2002 (SE) 0201709-3

(51) Int. Cl. B66F 9/06

(52) U.S. Cl. 187/229; 187/230

(57) ABSTRACT

Arrangement at truck mast constituted by three mutually telescopically moveable parts (1, 2, 3), which each include three vertical beams (4, 5, 6) placed in the corners of a triable. Between the middle mast part (2) and the fixed lowest mast part (3) a balance cylinder (11) is arranged in the central beam (5) of the next to the lowest mast part (2).

At trucks of different kinds it is well known to arrange the load forks in a telescopically extendable mast. In this way it is possible to achieve high lifting heights at the same time as the center of gravity can be kept low at transport. The telescopic mast also allow the passage of the truck through openings with far lower height than otherwise would be the case. The load forks are advantageously moveable height-wise in the uppermost mast part and at low lifts it sufficient to let the forks move in relation to this part (free lift). At higher lifts however the mast is extended. A known mast construction includes two or three more or less in each other running parts. Each part includes three vertical beams. The means are so placed that their projections on the ground constitute a isosceles triangle, which enables a construction that is strong in all directions. The mutual movements of the mast parts are coupled in known manner so that at a lifting movement all the mast parts move in relation to each other. The guides and lifting means for this are arranged close to the vertical beams that are arranged at the sides of the mast and the truck, while the third vertical part only has as its object to increase the resistance against bending of the mast lengthwise of the truck. This is not unessential since the driver with his platform at many trucks also is lifted together with the forks, as well as other means for load-handling, as fork pivot means.

A problem at this type of mast, and in particular when also the driver and his platform etc also is lifted, is that comparatively much energy is used to lift the mast up and down, that is the effective load that is lifted is comparatively small in relation to the total load that is lifted.

In order to remedy this problem it is in accordance with the invention suggested that between the lowest moveable mast part and the fixed mast part a balance cylinder is arranged in the moveable next to the lowest mast part in the central vertical beam alternatively in the central vertical beam of the lowest fixed mast part. In the conventional way the lifting cylinders are placed close to the beams of the mast at the sides of the truck.

The balance cylinder makes it possible to a great extent to balance out the weight of the lifted part of the mast so that the lifting energy that at lifting movements is needed essentially corresponds to he load on the forks. By furthermore arranging the balance cylinder inside one of the front beams the balance cylinder do not in any way infringe the field of view of the operator of the truck and an aesthetically clean exterior can be retained.

Since the moveable mast parts are coupled to each other so that they at an extending movement move relative each other the balance cylinder will even if it is only mounted between two mast parts at movement balance the weight of all the parts that are lifted. This is advantageously achieved by a chain being fastened to the lowest mast part and runs over a pulley or cogwheel on the next mast part and down to the lower end of the next mast part. The lifting hydraulic cylinders are arranged between the lowermost mast parts and when the mast part next to the lowermost one is pushed up by the lifting cylinders the chain also lifts the next mast part. If one would wish to have more mast parts than three a similar chain device can be arranged for uh additional mast part that is desired.

By placing the balance cylinder between the upper end of the second lowest mast part and the lower end of the part of the mast fixed in the chassis of the truck the balance cylinder can thus by means of the coupling of the movement balance the entire mast weight.

Alternatively the central vertical beams of the mast parts may be U-shaped, which simplifies the mounting of the balance cylinder. At this it is even possible to turn the beams for the lowest mast parts towards each other so that an extra large space is achieved for one or two balance cylinders.

Since the driver accompanies the mast control orders and other signals have to be transferred to and from the drivers platform and since load handling means as for instance free lift and pivot fork means are located close to the drivers platform electric leads as well as hydraulic conduits need to be connected to the work platform, which advantageously can take place in the central beams.

Further characteristics and advantages of the invention are apparent from the following description of an embodiment shown in the enclosed drawings. In the drawings

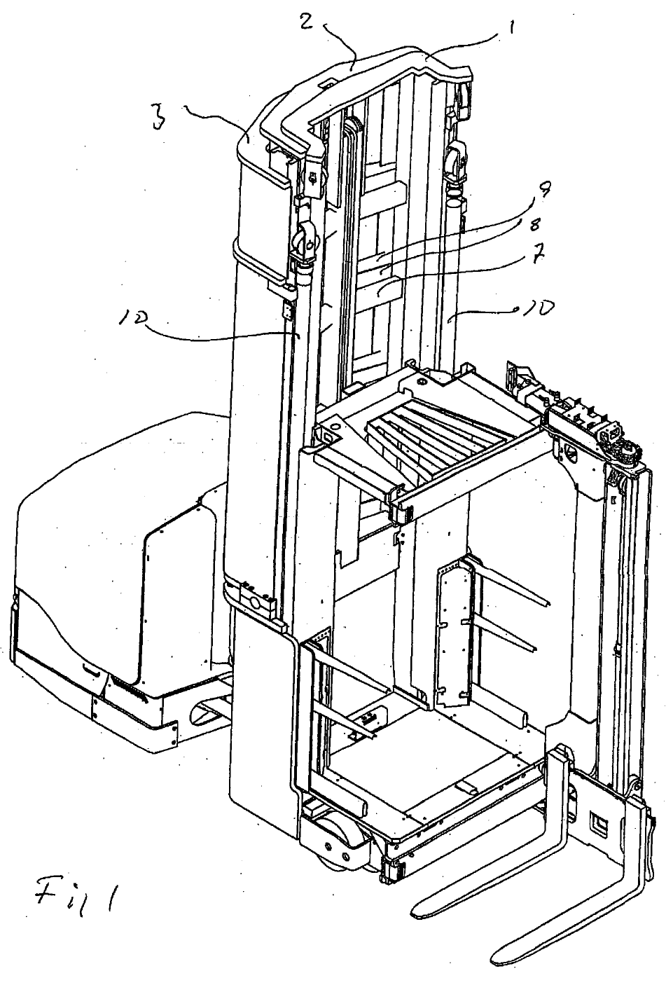

FIG. 1 shows a truck equipped in accordance with the invention and

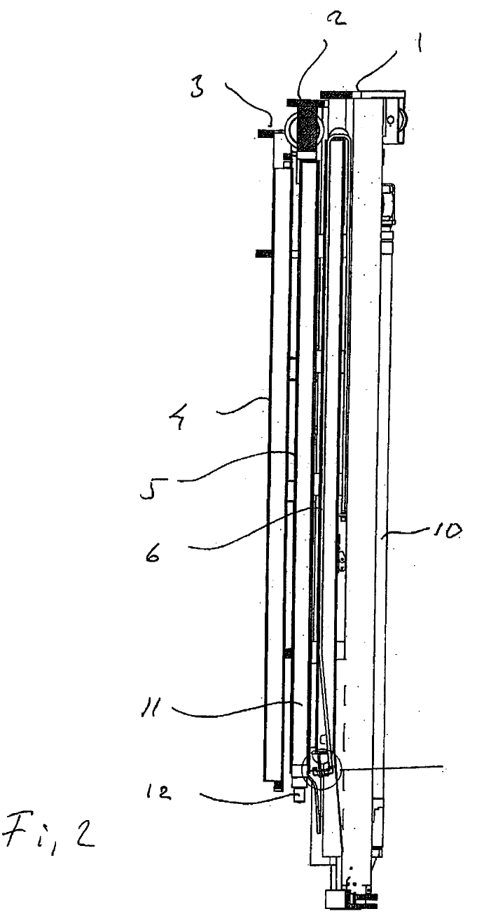

FIG. 2a mast in accordance with the invention in a vertical section.

The truck mast in the drawings is divided into three parts 1, 2 and 3 which are moveable relative each other. Each mast part includes two vertical beams at the sides of the truck and central beams 4, 5 and 6 respectively that are situated somewhat behind the others so that the base of each mast part constitutes a triangle. The lowest mast part 3 is fastened to the chassis of the truck and is the most outer one. Inside of this is the middle mast part 2 and the upper frame part 1. Cross connections 7, 8 and 9 respectively are arranged connecting the beams on the sides with the respective central beams, so that seen from above each mast part receives a slight V-shape. At the side beams lifting pistons 10 and lifting chains for the coupled movement of the mast parts are arranged in a known manner. The central vertical beams are all alike and U-shaped or tube-shaped and in the central beam of the middle mast part a balance cylinder 11 is arranged with its piston rod end downward. The piston rod 12 rests in its bottom end against the chassis of the truck or against a suitable crossbeam in the lowest mast part 3. The balance cylinder 11 is advantageously attached to a reservoir for pressurized air that increase the volume of the compressed air. The pressure in the balance system is adjusted so that the pressure if possible almost lifts the upper mast parts in the bottom position. When then the mast moves upward the air expand and the balancing pressure force is reduced. The larger the air volume that can be obtained in relation to the cross section of the balance cylinder the smaller this reduction is, but irrespective of this an essential contribution to the lifting force is obtained over the working height of the mast, which reduce the energy that has to be fed to the pump of the truck, and taken from the battery of the truck.

If so is desired the central vertical beams that do not contain any balance cylinder may be used for the location of hydraulic conduits as well as for electric leads.

Trough the above described arrangement the sighting field of the driver despite the arranging of balance cylinder and cables will remain unchanged.

1. Arrangement at truck mast constituted of two or several mutually telescopically moveable parts, which each include three vertical beams located in the corners of a triangle, characterized in that between the lowest moveable mast part and the fixed mast part a balance cylinder is arranged in the moveable next to the lowest central vertical beam alternatively in the central vertical beam in the lowest fixed mast part.

2. Arrangement according to claim 1, characterized in that the balance cylinder is arranged hanging, that is with the piston rod in the lower end.

3. Arrangement according to claim 1, characterized in that the mast includes three mast parts.

4. Device according to claim 1, characterized in that the balance cylinder is connected to a reservoir for pressurized air.

5. Arrangement according to claim 1, characterized in that the movements of the mast parts are coupled together so that all the mast parts move at an elongation or contraction.

6. Arrangement according to claim 1, characterized in that electrical cables and/or hydraulic conduit are arranged in the central beams of the mast.

7. Arrangement according to claim 1, characterized in that the truck is a driver lifting truck where the mast lifts a drivers cage together with load handling means.

8. Arrangement according to claim 1, characterized in that the load lifting means includes a free lift device and/or a swing fork means.
